(19) United States
(12) Patent Application Publication
(10) Pub. No.: US 2013/0325540 A1
(43) Pub. Date: Dec. 5, 2013

(54) Forecasting and Workforce Supply-Demand Projection System

(71) Applicant: Elation Systems, Inc., Pleasanton, CA (US)

(72) Inventor: Rick Shi, San Ramon, CA (US)

(21) Appl. No.: 13/907,750

(22) Filed: May 31, 2013

Related U.S. Application Data
(60) Provisional application No. 61/653,987, filed on May 31, 2012.

(51) Int. Cl. G06Q 10/06

(52) U.S. Cl. CPC G06Q 10/063118
USPC 705/7.17

(57) ABSTRACT

A forecasting system is disclosed that allows a user to create a project or body of work, define attributes for that project, select relevant historical data from a repository of historical data, and create a project forecast by scaling the historical data appropriately. The project forecast may include costs and workforce utilization forecasts. The workforce utilization and supply-demand forecast data may be broken down by trade, and the system may provide demographic and geographic information relevant to the workforce. In order to provide a rich corpus of historical data, certified payroll reports, or other sources that provide data down to the level of the individual worker, may be used to generate the cost and workforce forecasts.

### CROSS-REFERENCE TO RELATED APPLICATIONS

This application claims priority to U.S. Provisional Patent Application No. 61/653,987, filed May 31, 2012. The contents of that application are incorporated by reference herein in their entirety.

### RESERVATION OF COPYRIGHT

This application contains subject matter that is subject to copyright protection. The patent owner has no objection to the reproduction by anyone of this patent application as it appears in the files of the U.S. Patent and Trademark Office, but otherwise reserves all copyright rights whatsoever.

### BACKGROUND OF THE INVENTION

1. Field of the Invention

In general, the invention relates to forecasting, projection, and workforce supply-demand tools, and in particular, to tools that utilize historical data and user defined variables to define resources needed for a project and perform workforce supply and demand analysis.

2. Description of Related Art

Forecasting and projection are important tools for project management. Generally defined, these terms refer to the process of making estimates of the costs or other resources necessary to complete a particular project based on some type of historical data. Good forecasts and estimates can help to bring a project to completion without cost overruns or the depletion of resources.

In managing projects, particularly projects with varying magnitudes of complexity and specific resource requirements, it can be difficult to accurately forecast costs and other resource requirements. For example, in many types of construction projects, a human estimator typically reviews the project and performs budgeting and forecasting tasks based on personal experience. These human estimates are often inaccurate best guesses, and projects that rely on them may run out of funds or other resources.

While computerized budgeting and cost estimating systems that draw from databases of historical data do exist, these systems have several shortcomings. First, these systems tend to focus on costs and material quantities, and do not generally consider the workforce that will be necessary to complete the project.

Second, and perhaps more importantly, existing cost budgeting systems tend not to consider the full environment in which major projects are designed, authorized, and completed. More particularly, major projects are often undertaken by government entities and large businesses. With these types of entities, cost is certainly one concern, but the effects of a project on the local workforce may be an equal or greater concern. In certain situations, projects are more likely to be authorized if they have a positive effect on the local workforce, e.g., by requiring a large number of jobs in a local area.

In addition to the total number of workers a project might employ in its various stages, some governmental and business entities place diversity requirements on contractors and other vendors who work on projects, requiring, for example, that a certain percentage or number of the workers be female or minorities. However, tools for performing detailed workforce supply and demand projections for specific projects are lacking, and it can be difficult even to find a cohesive, reliable source of data on which to base these kinds of forecasts. This makes it difficult for contractors and other project implementers to know whether they can comply with these requirements and to take appropriate steps in the planning of a project.

### SUMMARY OF THE INVENTION

One aspect of the invention involves a forecasting system. The system includes a data repository in which historical and current project data is stored and a server in communication with a plurality of computing devices through a computer network. The system and server may serve a single organization or a number of different organizations. If the system and server serve a number of organizations, they may allow the organizations to collaborate on common projects.

In embodiments according to this aspect of the invention, the server provides an interface that allows a user to create a project or body of work, define attributes for that project, select relevant historical data from the data repository, and create a project forecast by scaling the historical data appropriately. The project forecast typically includes costs, workforce utilization forecasts, and workforce supply-demand projections. The forecast data may be broken down by trade, and in addition to the forecast data, the system may provide demographic and geographic information. For example, the system may use historical data or other data to compare the forecast data with the number of available workers in a particular trade in the geographical area in which a project is located, and may provide a demographic breakdown on the workers, indicating, for example, how many workers are projected to be female or minorities at any point in the project.

Other aspects of the invention relate to methods for estimating projects using historical data. These methods generally involve selecting relevant project attributes and generating an estimate by using historical data to scale project costs associated with the attributes. The estimates produced may include cost estimates, material estimates, and workforce supply-demand estimates.

Yet other aspects of the invention provide policy support tools that allow policymakers, executives, and others to understand workforce supply and demand relative to a particular planned project, or a set of projects and, thereby, to determine whether steps need to be taken to increase the supply of workers overall or in particular trades.

These and other aspects, features, and advantages of the invention will be set forth below in the description that follows.

### BRIEF DESCRIPTION OF THE DRAWING FIGURES

The invention will be described with the respect to the following drawing figures, in which like numerals represent like elements throughout the figures, and in which:

FIG. 1 is a high level illustration of a system according to one embodiment of the invention;

FIG. 2 is a high level flow diagram of a forecasting process using the system of FIG. 1;

FIG. 3 is a flow diagram of an algorithm for using user defined variables and historical data to create a project according to the process of FIG. 2;

FIG. 4 is an illustration of one part of a graphical user interface (GUI) that may be used with the system of FIG. 1 that allows a user to define project variables;

FIG. 5 is an illustration of another part of the GUI that allows the user to view historical projects from project categories;

FIG. 6 is an illustration of another part of the GUI that displays a listing of new projects and allows the user to edit project attributes.

FIG. 7 is an illustration of another part of the GUI that displays project categories and allows the user to modify projects within the categories;

FIG. 8 is an illustration of another part of the GUI that displays a forecasting report;

FIG. 9 is an illustration of another part of the GUI that displays a forecasting report by completion periods;

FIG. 10 is an illustration of a part of the GUI that displays a resource demand overtime analysis report in blocks of projected overtime; and

FIG. 11 is an illustration of a part of the GUI that reports workforce utilization in numerical values and pictorial graphs.

### DETAILED DESCRIPTION

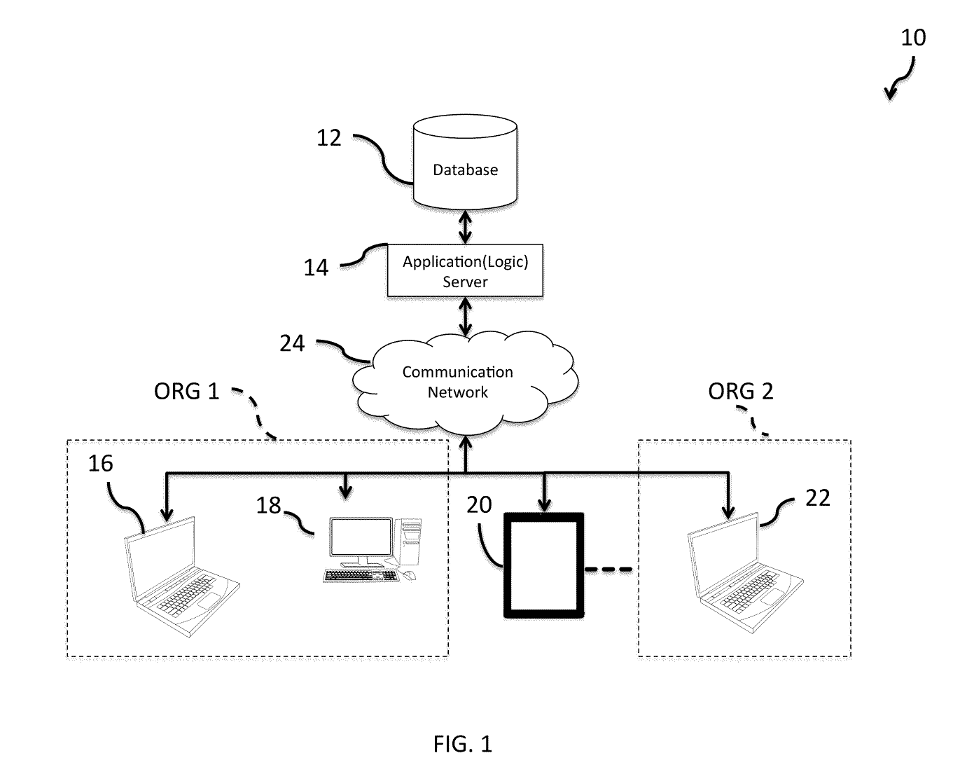

FIG. 1 is a schematic illustration of a system for project forecasting, generally indicated at 10, according to one embodiment of the invention. System 10 includes a data repository 12, a server 14, and a plurality of computing devices 16, 18, 20, 22. The computing devices 16, 18, 20, 22 are in communication with the server 14 and the data repository 12 via a communication network 24. As will be described below in more detail, among other functions, system 10 provides an integrated system for estimating and forecasting project costs and performing workforce supply and demand analysis based on historical data.

Many of the functions ascribed to system 10 in this description are performed by software routines implemented on the server 14, which stores data accumulated in system 10 in the data repository 12. The term “software routines” in this description should be construed to refer to a set or sets of machine-readable instructions that are encoded on a machine-readable medium (e.g., a hard disk drive, floppy disk drive, USB drive, SD/SDHC card, COMPACT FLASH card, CD, DVD, etc.) that, when executed, cause the server 14 or computing devices 16, 18, 20, 22 to perform the functions described. Depending on the nature of the computing devices 16, 18, 20, 22 that are used in system 10, some of the computing routines and functions may be distributed to the computing devices 16, 18, 20, 22 and some data stored or replicated locally on the computing devices 16, 18, 20, 22.

The server 14 may be, for example, a Web server capable of providing information via hypertext transfer protocol (HTTP) over a packet-switched network that uses a protocol or set of protocols such as Transmission Control Protocol/Internet Protocol (TCP/IP). The server 14 may use any software to serve information, and may include any features typical of a Web server. As one example, the server 14 may use APACHE web server software (The Apache Software Foundation, Forest Hill, Md., United States) to serve Web pages. It may also use any type of server-side scripting language or server-side Web application framework to serve dynamic content, in which the pages or outputs that the user sees are constructed dynamically by the server 14 based on information in the data repository 12. A number of server-side scripting languages and Web application frameworks are known in the art and any may be used. Examples include the PHP scripting language and Microsoft's ASP .NET Web application framework.

Although the server 14 is shown as a single element for ease and clarity in illustration, the server 14 may, in fact, comprise multiple computing systems that are configured to act cooperatively. In some embodiments, these multiple computing systems may be configured to appear to other systems over the communication network 24 as a single logical machine.

The data repository 12 may be, for example, a Structured Query Language (SQL) database with a number of tables, such as a MySQL database. In some embodiments, the data repository 12 may be implemented on the same physical system as the server 14. In other embodiments, a separate computer or computers may implement the data repository 12, and another computer or computers may provide the functions of the server 14.

In some embodiments, the components of system 10, and in particular, the server 14 and data repository 12, may be housed, controlled, and used by a single organization. The server 14, for example, may exist in a company's in-house data center, and may provide its data over an in-house local area network (LAN). In that case, the server 14 would typically still use traditional Internet-based protocols and technologies, including HTTP to transfer information between the server 14 and the computing devices 16, 18, 20, 22; it would simply be located behind an organizational firewall to prevent unauthorized access.

However, in many embodiments, system 10 may be “cloud based.” “Cloud based” systems are those in which the server or servers are owned and operated by one entity and service a number of organizations or users. In these arrangements, the functionality of the server 14 and the data repository 12 would typically be provided by a large scale data center whose computing systems may or may not run other software of services as well. With cloud-based systems, the organizations get the benefit of using the system and its functionality without having to maintain it, and can typically access the cloud-based system from any computing device 16, 18, 20, 22 using a Web browser or an application compiled for a particular platform. In the illustration of FIG. 1, two of the computing devices 16, 18 belong to one organization, ORG1, while another computing device 22 belongs to a second organization ORG2.

If system 10 serves a number of different organizations, it may do so in several different ways. One advantage of having a system 10 that serves multiple organizations is that it can allow those organizations to work together on collaborative projects. In that case, users from multiple collaborating organizations may see the same sets of data from system 10. (Although even if data is shared, permissions and security measures may be used to secure some data that is proprietary, confidential, or not relevant to other organizations, so that it stays within its organization.) Collaboration is common and can be important, particularly in construction projects where a prime or general contractor oversees several hierarchical tiers of sub-contractors and sub-sub-contractors.

In other cases, system 10 may be set up so that although multiple organizations use the system, each organization sees only its own data. In those cases, the organizations using system 10 may be unaware of the other organizations using the system. Particular organizations may be given the opportunity to “privately brand” system 10, such that it includes the organization's logo and graphics. If multiple, separate organizations are served by system 10, several data repositories 12 may be used some embodiments to ensure that data from different organizations is kept separate. For example, multiple SQL databases may be used as data repositories in a cloud-based implementation of system 10, each database having a similar schema or data storage arrangement. It should be understood that a single embodiment of system 10 may handle both of the cases described above—i.e., a server 14 and data repository 12 may simultaneously serve both sets of collaborating organizations and any number of separate, unitary organizations.

On the client side, the functions of system 10 may be accessed using essentially any type of computing device, including desktop computers, laptop computers, smart phones, and tablet devices. In many embodiments, the computing devices 16, 18, 20, 22 will be general purpose laptop or desktop computers running browser software, such as Microsoft INTERNET EXPLORER, Apple's SAFARI browser, FIREFOX, or Google's CHROME browser, to name a few. Client-side technologies like JavaScript and AJAX may be used to provide a full-featured interactive user interface within the browser, as is well understood in the art. Additional technologies, like Adobe FLASH, may be used to provide cross-platform audiovisual capabilities. As those of skill in the art will realize, any number of computing devices 16, 18, 20, 22 may be used and supported in system 10, such that system 10 may have many concurrent users.

The advantage of a browser-based interface is that the interface is cross-platform and will work on almost any computing system that can run the browser software. However, in some cases, standalone compiled or interpreted interface applications may be used. For example, computing device 20 of FIG. 1 is a tablet-computing device. A compiled application or app may be used to implement system 10 on that device 20, rather than using a browser-based interface. Compiled applications may be particularly helpful when the device cannot run full-featured browser software, when it is desirable to take advantage of specific features of the device, or when more local storage and processing of data may be useful in reducing the amount of data that is downloaded from the communication network 24.

The architecture of the system 10, described above, is broken down into distinct layers of functionality and may be implemented utilizing different technologies. Similarly, the data repository 12 may be implemented using any one of several widely used internal data storage architectures and technologies, including unstructured databases, as well as structured databases. Additionally the data contained within the data repository 12 generally conforms to a structure and set of defining rules that allows for the data members to be mapped and related to one another.

The actual data in the data repository 12 will vary with the type of project and the type of available data relating to that project. In general project management embodiments, data is collected and arranged around centralized information sets, such as project documentation (e.g., regulatory documentation requirements), project management methodologies, financials, and resources. These information sets provide certain types of project information down to a certain level of granularity, particularity, or specificity. However, in many projects, the available data may focus on the relationships between contracting entities, and may not provide information on the level of the individual workers.

Worker-level detail may be particularly helpful in performing forecasting and budgeting activities, as well as for business and workforce supply-demand analysis. For instance, these details may be used to describe relationships between cost, worker location, and trade specialties. The use of worker-level detail to perform forecasting and budgeting tasks will be described in greater detail below.

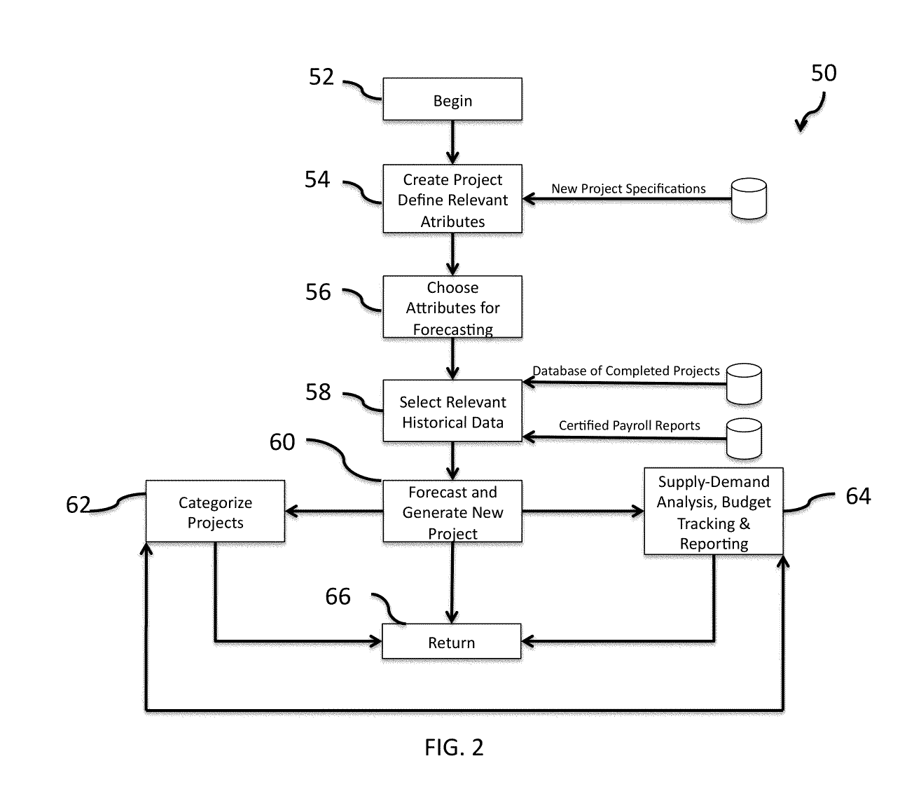

FIG. 2 is a high level flow diagram illustrating tasks in an integrated method, generally indicated at 50, for project forecasting. As will be described below in more detail, in some embodiments, method 50 may be used solely for budgeting; in other embodiments, method 50 may also perform workforce supply-demand analysis and act as a policy support tool. FIG. 2 also illustrates, schematically, some of the input data to method 50.

Method 50 begins at task 52 and continues with task 54. In task 54, a user creates a project by defining relevant project attributes. Project attributes are pieces of information that help define characteristics or qualities of an object or piece of work. These project attributes may come from project specifications derived from project bid requirements at a high level, or engineering designs or schematics at a detailed level. Some embodiments of the forecasting system 10 may track attributes as solitary pieces of information; in other cases, they may be logically categorized as a group. For example, a project may track attributes such as worker types, raw material quantities, time and material cost estimates, and physical worksite sizes and locations. These attributes can be then grouped together into categories such as labor, which may include worker types and time estimates, and materials, which would include raw material quantities and material cost estimates.

In general, a project may be categorized by project or worksite type, for example, industrial/commercial projects; entertainment venues and malls; linear pipe or roadway works; and residential housing projects. Each of these project or worksite types may have associated attributes, such as units of length for water or gas piping initiatives. Residential housing projects, on the other hand, may have attributes such as number of floors, number of total units, and unit square footage. The user may use pre-defined attributes and project categories that exist in the system 10, or may define custom attributes and project categories unique to a body of work. Many common attributes comprise unit measures such as square footage, length, volume, quantity, and cost. Projects themselves may have a combination of categories and attributes; for example, a work-live construction project may have a commercial retail component on the ground floor and residential housing units on floors above, so the resulting project may have attributes of both commercial and residential projects.

When task 54 is complete and the user has selected the appropriate attributes, a project is created with the defined attributes and is added to a list of new or current projects of system 10.

Method 50 continues with task 56, in which the user selects attributes to be used in forecasting calculations. While a project may have any number of attributes, as those of skill in the art will realize, only some of those attributes will be “result effective” or likely to influence an estimate, forecast or projection. Thus, the user defines attributes in task 54; however, the user can decide not to use all of them in subsequent forecasting steps of method 50. This may be useful, for example, in construction embodiments where a contractor may choose not to include certain materials or labor in an estimate or budget, either because they are offering a discounted cost or because there is no incremental cost to them (e.g. because the labor or materials are free of charge).

As shown in FIG. 2, the next task of method 50 is task 58, in which the user selects relevant historical data to which to apply the selected attributes. Historical data, in the simplest terms, is a collection of completed bodies of work that may be used as references for future projects.

Systems and methods according to embodiments of the invention may use any type of historical data. As those of skill in the art will appreciate, most project estimators have at least some type of historical data, e.g., old estimates and invoices, payroll records, receipts, etc., and all of these can be used in systems and methods according to embodiments of the invention. However, as was noted briefly above, historical data that offers both depth and granularity (i.e. particularity) down to the level of the individual worker can be especially helpful, and historical data that allows a user to estimate both the monetary costs of a project and the labor/workforce utilization at each stage of a project can be very advantageous.

The present inventor has found that, when available, certified payroll reports are a particularly helpful source of historical data. These reports, mandated by the U.S. Department of Labor for contractors working on government projects, include information down to the pay, trade, address, and other demographic information of each individual worker on a job. In a typical certified payroll report, the first section contains header information, i.e., name of contractor or subcontractor, business address, payroll number, payroll week ending date, project name and location, and project number. Additionally, the first section includes payroll summary information, i.e., employee name and identification number, withholding allowances, work classification, hours worked, including day and date and overtime hours, total hours, rate of pay and cash fringes, gross wage deductions, and net wages paid for the week. The second section is a statement of compliance which includes date of submission, name of submitter and title, company name, project name, work begin date, work week end date, deduction statement, fringe benefit information, exceptions, remarks, printed name and title of submitter, and written signature.

In order to use this information as historical data, information from individual certified payroll reports is extracted from the fields of the certified payroll report and stored in the data repository 12. In some embodiments, a company using method 50 may have its certified payroll reports prepared by entering the data into a computer system, and that data may be shared or imported into the data repository 12 as historical data. In some embodiments, the same company providing system 10 and method 50 may accept data for, process, and create certified payroll reports for a plurality of customers, and those same customers (or different ones) may be offered the opportunity to use that certified payroll report data as historical data for purposes of system 10 and method 50.

It should be understood, however, that system 10 and method 50 need not be used only for government projects where certified payroll report data is available. If a company does only some of its business with the government, the projects for which certified payroll reports are prepared and available may be a sufficient corpus of historical data to allow other projects to be estimated. Additionally, although portions of the description below focus on a company's using its own historical data as a basis for estimation, in some embodiments, a broader corpus of historical data gathered from a plurality of companies could be used as a general historical database for estimating, although a database or corpus of data drawn from multiple companies or sources may need to be anonymized or otherwise altered to remove proprietary and/or confidential information, to use such information only in the aggregate, or to shield the end user from the source data. In some embodiments, system 10 and method 50 may function using general historical data drawn from multiple or other sources until enough projects have been input into system 10 to form a suitable body of historical data. Finally, as those of skill in the art will appreciate, historical data that includes at least some of the data found on a certified payroll report may be used in essentially the same way as a certified payroll report itself.

The historical data may be grouped into categories, as described above, or it may be uncategorized. It is important for a user to select historical projects that are relevant to a piece of work they are trying to forecast to come to a meaningful estimate. Of course, the user typically defines exactly how historical data is relevant to the current project, and may choose historical data based of project types, cost, sizes, locations, completion dates, durations, resource types and utilizations. In the government construction embodiment, one historical project may be selected because it is related in type, another project may be selected because it relates by location, which may account for local construction codes and labor laws, and yet another may be selected based on the completion date, to account for more recent labor and material costs.

In addition to specific historical data, system 10 and method 50 can also take into account general historical data and variables that are not within the user's control and that are not directly related to the attributes of the project per se. As one example, the state of the economy can affect both the labor supply and the cost of labor and materials. Therefore, in some embodiments, the user may supply or select general historical data regarding the state of the economy in task 58. For example, the user might be asked to indicate, on a scale of 1-10, the state of the economy at the time that a historical project was performed relative to the current state of the economy. Alternatively, the data repository 12 could include, or system 10 could be provided access to a database of appropriate historical economic indicators. Once appropriate historical data has been selected in task 58, method 50 continues with task 60, in which a forecast and new project are generated.

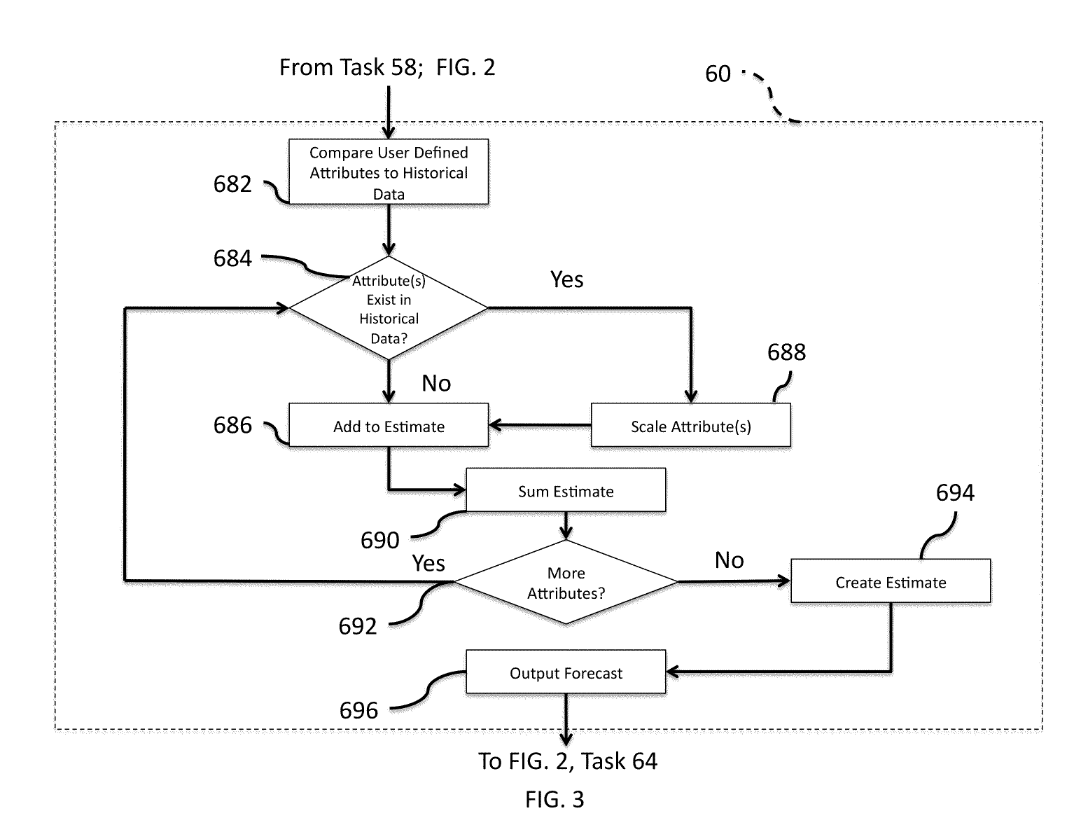

Task 60 involves a number of sub-tasks and is itself a method. FIG. 3 is a high level flow diagram of the sub-tasks involved in task 60. Task 60 begins with subtask 682, where the user-selected attributes are compared against the attributes that exist in the set of chosen historical data. The purpose of subtask 682 is to determine if there are user defined attributes that can be used in scaling calculations in subsequent subtasks of task 60. Subtask 682 may compare user-selected attributes individually against individual attributes in the historical data, or the attributes may be compared to one another in sets. Attributes defined by the user which also exist in historical data may be used in scaling calculations in subsequent steps of method 50. New attributes that are not historically tracked may be added to scaled attributes as a constant estimate to render a forecast. This may ensure that uncommon requirements or special project costs are accounted for. For example, beyond typical construction requirements, there may be additional local construction codes or labor laws, structural safety enhancements, and accessibility needs, all of which may incur significant additional costs.

Task 60 continues with sub-task 684, a decision task which directs the process flow to the next task depending on whether the user-selected attribute or attributes exist in the historical data. If the attribute or attributes do not exist in the historical data (task 60, condition 684: NO), they are treated as mathematical constants and are simply added to the working estimate in task 60, subtask 686, before the working estimate is summed in task 60, subtask 690.

If the user-selected attribute or attributes exist in the historical data (task 684: YES) the flow is directed to task 60, subtask 688. This subtask scales the user-selected attributes for the new project against the selected historical data.

The scaling activity of subtask 688 may be performed utilizing any of several common mathematical methods, depending on the circumstances. One set of mathematical methods, linear and nonlinear programming, focus on maximizing and minimizing values, such as maximizing profit while minimizing cost. Estimates can also be calculated by employing calculus, utilizing bounds or limits, in which case an estimate is expected to be at least a certain amount (i.e., a lower bound), and not to exceed a certain amount, (i.e., an upper bound).

Statistical analysis may also be used, and more specifically inferential statistics, which uses patterns in the sample data to draw inferences about the data to account for randomness. Inferential statistics involves describing associations between sample data and assigning further mathematical procedures depending on the defined associations. In the simplest embodiments, inferential statistics may involve inferring that the costs for one historical project will scale linearly with increasing or decreasing project size, and simply multiplying the costs for a historical project by an appropriate multiplier to estimate the costs for a new project.

One of the most common methods of performing the analysis and scaling tasks is by regression analysis. Regression analysis focuses on the relationship between dependent variables, i.e., the user defined attributes, and one or more independent variables, i.e., the historical data. More specifically, the scaling is performed when the user-defined attributes are changed according to the variations in corresponding historical data. User-defined attributes that do not have corresponding historical data remain fixed. In various fields of application, different terminologies are used in place of the terms dependent and independent variables, e.g. dependent variables being user defined attributes and independent variables being historical variables.

There are several regression models available; however, they typically involve the following variables: unknown attributes, usually denoted as β, which may represent a scalar or vector; independent variables (historical data), usually denoted as X, and dependent variables (user-defined attributes), usually denoted by Y. Any regression model relates Y to a function of X and β, i.e. Y≈f(X, β). The function f(X, β) may be constructed using any mathematical method mentioned above, or other methods that fit the problem space of the scaling. The embodiments of invention may utilize any combination of methods for forecasting purposes depending on the type and complexity of the project.

Once the attribute or attributes are scaled, they are added to the working estimate, as shown in task 60, subtask 686. Task 60 then continues with subtask 690, where the estimate is summed. Once the estimate is summed, task 60 continues with subtask 692, a decision task, where it is determined if there are any more attributes that have not been added to the estimate. If there are more attributes (task 60, subtask 692: YES), task 60 returns to subtask 684. On the other hand, if there are no more attributes that need to be added to the estimate (subtask 692: NO), the final estimate is then created at task 60, subtask 694 by formatting the figures and correlating them to the appropriate attributes.

Task 60 concludes with subtask 696, in which the forecast is created by applying the estimates to the new project and is made available for user viewing. At the conclusion of task 60, method 50 may complete and return at task 66, or, if the user chooses, there are two optional tasks that may be performed.

Method 50 may continue to task 62 where the user may choose to categorize the project. The categorizations may already exist in system 10, or the user can choose define them. In this task, the user may place the project into the proper category or may also choose to re-categorize existing project-category relationships. At the conclusion of this task, method 50 may continue to task 64 or simply complete and return. If the user chooses to proceed with method 50, task 64, the user may view system-generated views of resource utilization and supply-demand analysis, budget-tracking information, and system-generated reports. At the conclusion of task 64 the user may go back to method 50, task 62 or complete method 50 and return at task 66. The user may choose to go to either method 64 or method 62 at the conclusion of method 50, task 60.

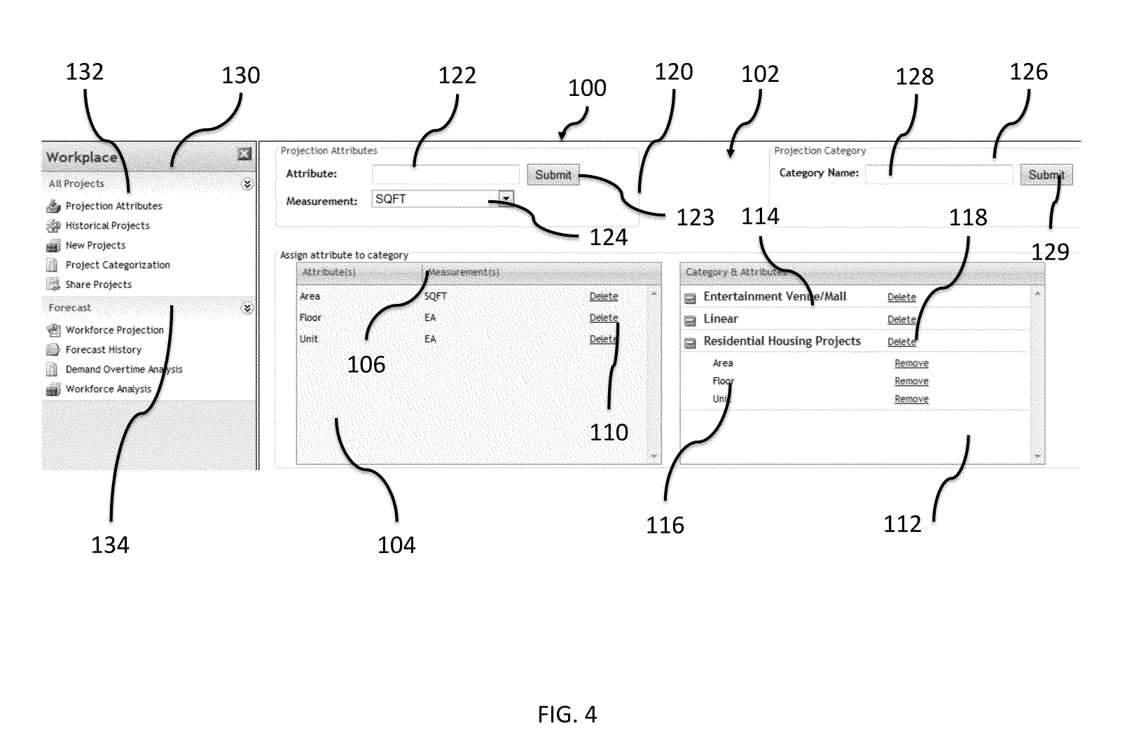

FIG. 4 is an illustration of one part of a graphical user interface (GUI), generally indicated at 100, that may be used in system 10 and method 50. The GUI workspace 102 includes an attribute definition pane 120 where the user inputs an attribute name in an attribute field 122, selects a unit of measurement in an attribute drop down box 124, and presses a submit button 123. Project categories may be defined in a projection category pane 126 where the user inputs the name of a project category into a category name field 128 and presses a submit button 129.

Defined attributes appear in an attributes pane 104, which displays a list of user-defined attributes by name and measurements. The attributes may be sorted by depressing the corresponding sorting bar blocks 106, for sort by attributes 106 and sort by unit of measurement 108, at the head of the attributes pane 104. Actions links 110 enable the user to perform actions on an attribute, such as deleting by selecting the corresponding action link for an attribute.

Project categories and their attributes are listed in a category and attributes pane 112 where there is a listing of project categories 114 and their associated attributes 116. Action links 118 similar to those described above enable the user to take actions such as removing or deleting attributes and project categories respectively.

Additionally the workspace 102 enables the user to select attributes in the attributes pane and drag and drop them into the appropriate category in the category and attributes pane 112. The user is also able to drag and drop attributes from project category to project category within the project pane 112 itself.

The GUI 100 in the illustrated embodiment may also include a navigation bar 130 with two sections containing actions and views of the flow described in FIG. 2 above. The first section may comprise an expandable and collapsible listing of links to pages that provide project actions 132, such as projection attributes, historical projects, project categorization. The second section of the navigation bar may comprise an expandable and collapsible listing of links to pages that provide forecasting actions 136, such as workforce projection, forecast history, demand overtime analysis, and workforce supply-demand analysis. The navigation bar described in this figure is similar to those described in subsequent figures and illustrations.

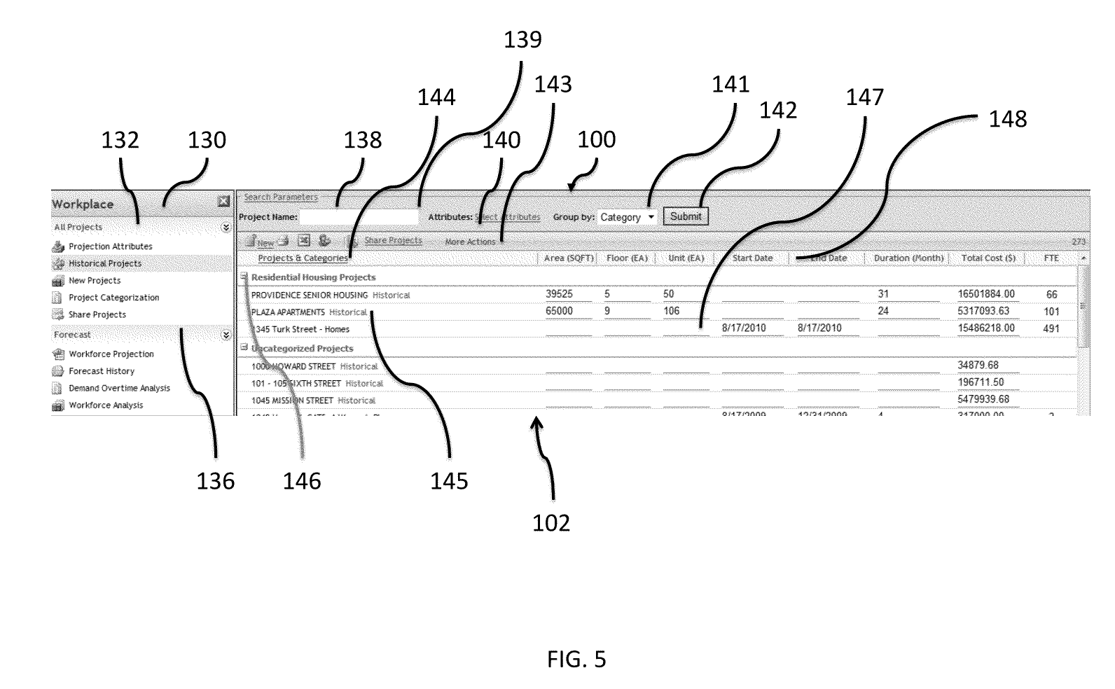

FIG. 5 is an illustration of another part of the GUI 100 that allows the user to view historical projects from project categories. A search pane 138 allows the user to search for a project by name by entering a project name in a project name field 139, selecting attributes via a dialog box that appears from selecting a select attributes link 140, and grouping the resulting projects that meet the search criteria in elements 138-140 by selecting a grouping criteria from a group by drop down list 141 and finally pressing a submit button 142. The results populate in the workspace 102, and are listed by project name 145 and project category 146. Projects without specific categorization are listed under the category “uncategorized projects.” Project attributes 147, if they exist, are also listed with their respective projects. Projects may be sorted within their categorized listings by depressing the appropriate attribute listed in a sorting bar 148. Projects may also be selected via a pop up dialog box by selecting projects and categories link 144 instead of using the project search pane 138.

FIG. 5 also illustrates an action bar 143 where actions may be taken such as creating a new project, outputting the screen data to a printer, exporting the screen data to a spreadsheet, sharing the screen data with another user, sharing selected projects with a user, and further actions defined by the implementation of the GUI 100.

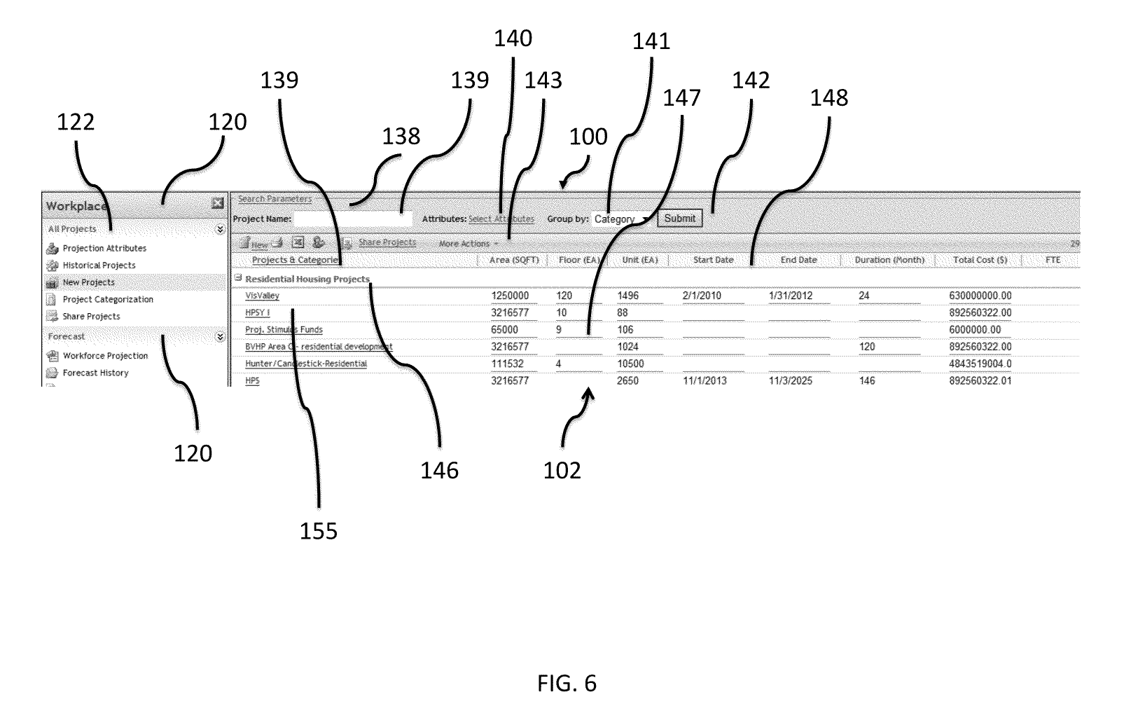

FIG. 6 is an illustration of another part of the GUI that displays a listing of new projects and allows the user to edit project attributes. Similar to the display method described above in FIG. 5, FIG. 6 lists new, uncompleted projects, in a categorized view. Additionally, the illustrated embodiment of the GUI 100 allows projects to be selected for editing by selecting the project name links 155. The attribute fields 147 will then allow for values to be modified.

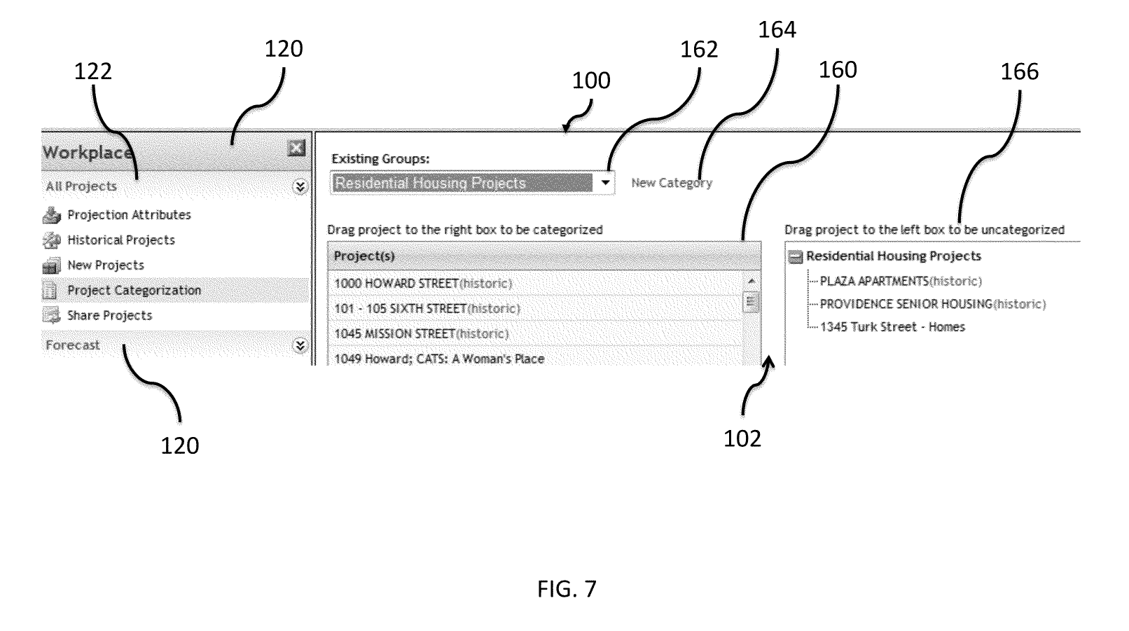

FIG. 7 is an illustration of another part of the GUI that displays project categories and allows the user to modify projects within defined categories. Uncategorized projects are listed in an uncategorized project scroll box 160. The user may choose an existing project category from a group-listing drop down list 162 or may define a new project category by selecting a new category link 164. Additionally, the user may choose to categorize projects by dragging and dropping projects from the uncategorized project scroll box 160 to a categorized project-listing tree 166. Conversely, the user may choose projects from the categorized project-listing tree 166 and drag and drop them to the uncategorized project scroll box 160 to uncategorized projects.

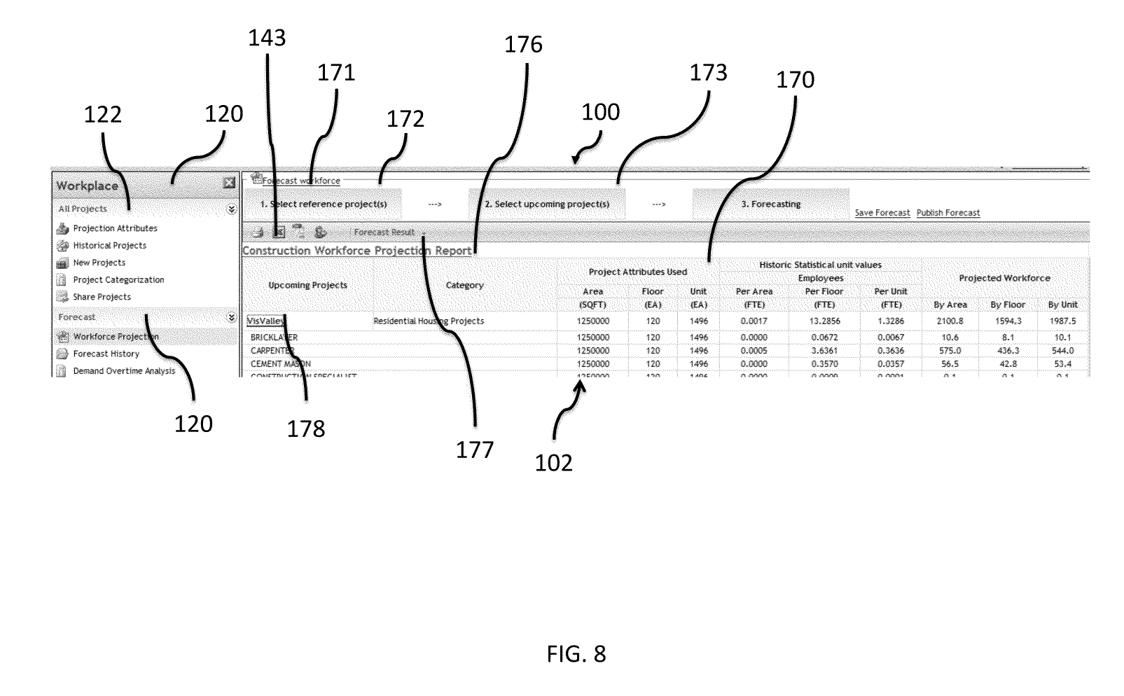

FIG. 8 is an illustration of another part of the GUI that displays resource projections for a particular project with unit value details. This part of the GUI 100, takes the user through an interactive forecasting flow after the user defines project attributes and categorizations in previous descriptions of the GUI 100. These basic functions were described above with respect to tasks 54-58 of method 50.

To start the flow, the user selects a forecast workforce link 171 or by selecting forecasting GUI element 172. Historical reference projects are selected from a dialog box in the GUI workspace 102. The user is then prompted to select new, upcoming, projects from a dialog box in the GUI workspace or can do so by selecting forecasting GUI element 173. The last part of the user interactive forecasting flow, allows the user to engage system forecasting scaling tasks described in FIG. 3 above, or the user can perform this task by selecting GUI element 174.

The user is also able to choose other forecasting actions in a forecast result action drop down list 177. Additionally, forecasting results can be saved or published by selecting a save forecast or publish forecast link in a forecast finalization pane in the GUI 100. Saving the forecast allows users to reference the project for review, but without applying the forecast values to the project itself, whereas publishing the forecast applies the attribute values to the project. After forecasting activities are complete, the user may generate a report by selecting a construction workforce projection report link 176. Forecasting results are displayed in the GUI workspace 102. The forecasted project 178 is displayed with a listing of project resources, and project category and attribute values are displayed in appropriate areas under a project view header 170.

In the illustration of FIG. 8, the GUI workspace 102 displays a workforce utilization and supply-demand projection, including a listing of trades (bricklayer, carpenter, cement mason, etc.) in one column, the attributes of the current project that are used for forecasting, the relevant historical statistical unit values in the next column, and the projected workforce in the final column. For example, for a 1.25 million square foot residential housing project with 120 floors and 1,496 residential units, a workforce of 2100.8 is projected by area, based on a historical value of 0.0017 full-time equivalent (FTE) workers per square foot. However, in embodiments of the invention, the user may be provided with more than one estimate or forecast. In FIG. 8, the workforce utilization projection also shows an estimate of 1594.3 FTE workers total based on a historical unit value of 13.2856 workers per floor, and 1987.5 workers by residential unit, with a historical unit value of 1.3286 workers per unit. These worker estimates are broken down by individual trade in the following rows.

If different forecast numbers are provided based on different variables, as is the case above, then those forecast numbers may themselves be subjected to further mathematical or statistical processing to arrive at a single forecast number that is presented to the user. For example, the different forecast numbers could themselves be subjected to a regression analysis using historical data to determine a final estimate.

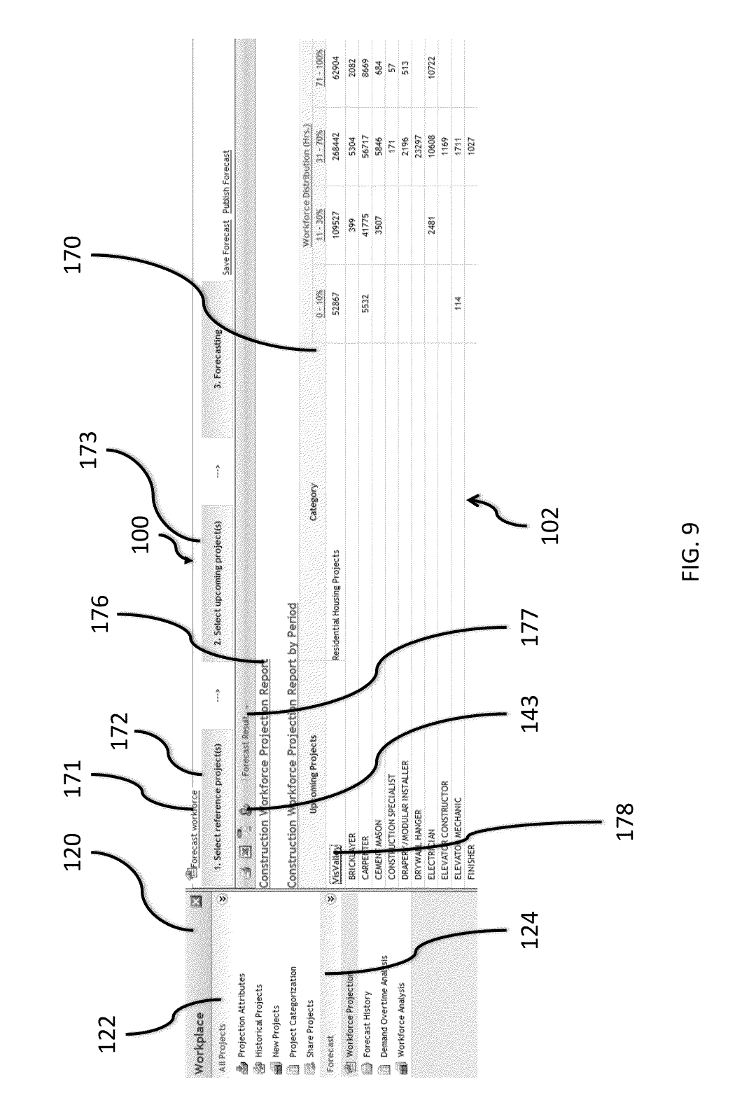

FIG. 9 is an illustration of another part of the GUI that displays a forecast report and workforce supply-demand analysis by completion periods. More particularly, in addition to an overall estimate or forecast of the number of workers or tradesmen needed to complete a project, system 10 and method 50 also allow the user to see a breakdown of when those workers will be needed. In the illustration of FIG. 9, the user is shown workforce distribution by the percent completion of the project, both as a whole and for each individual trade. For example, the forecast of FIG. 9 projects that only 399 hours of work will be required from bricklayers in the 11-30% project completion phase, but that 5,304 bricklaying hours will be required in the 31-70% completion phase.

Essentially, FIGS. 8 and 9 present resource projection curves in tabular form. These resource projection curves allow resources to be reserved and engaged during appropriate times of the project. This can be helpful in project management for several reasons. First, it helps to avoid situations in which workers are hired prematurely and are then made to stand idle; and second, the forecasts allow project planners to determine, in a gross sense, whether an adequate number of workers or tradesmen are available in the geographic area around the project. For example, if 50 FTE carpenters are required for a particular phase of a project, but only 40 practicing carpenters are available within a 50-mile commuting radius of the project, special arrangements may need to be made, or significant amounts of overtime may need to be included in the project costs.

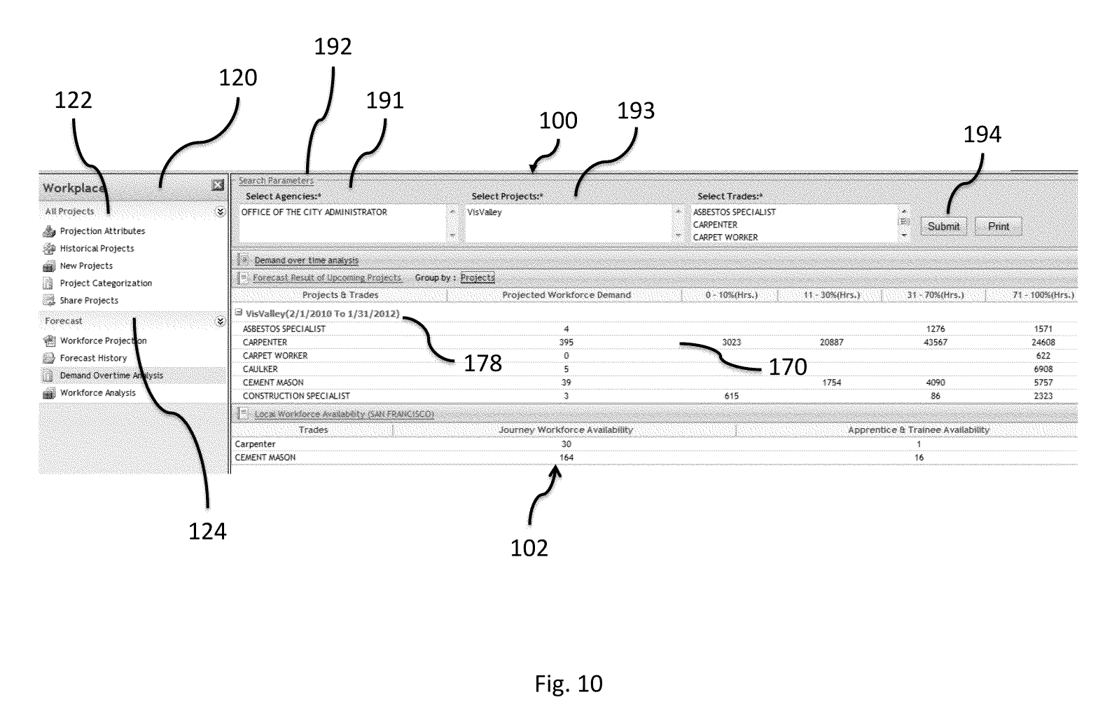

FIG. 10 is an illustration of a part of the GUI that displays a number of types of information, consolidating some of the information displayed in FIGS. 8 and 9, adding more information on local workforce availability, and including an overtime projection feature. In order to view this information, the user may select a project and appropriate resources for overtime analysis by searching for projects utilizing a search or selection pane 191. Within the selection pane, the user may specify search parameters by selecting a search parameter link 192, choosing search attributes from a dialog box, and pressing a submit button 194. The user may also select projects and resources by choosing agency listings, project listings, and trades within scroll boxes 193 and pressing the submit button 194.

The portion of the GUI 100 shown in FIG. 10 presents the workforce requirements and workforce utilization forecasts of FIGS. 8-9 in addition to a local workforce availability analysis. As was noted briefly above, there are a finite number of qualified tradesmen and/or workers in commuting vicinity of any construction project. The number of tradesmen or workers in any particular trade can be determined from publicly available data sources, including professional licensing board data and payroll data, such as from a database of existing, filed certified payroll reports. Comparing the number of available tradesmen in the local geographical area with the projected workforce utilization in any particular trade allows system 10 and method 50 to develop a demand overtime forecast. As was noted briefly above, if the number of hours of work required in a trade exceeds those that can be performed by the available workers, then the excess is generally accounted for with overtime. In the particular illustration of FIG. 10, the workforce availability report is broken down into the number of journeymen available in a particular trade in a particular area and the number of apprentices and trainees available in that area.

In the illustration of FIG. 10, the project may be assumed to be in the San Francisco geographical area, and the GUI 100 shows the workforce availability analysis for that region. System 10 may include in the data repository 12 information on various geographical regions and their boundaries. It may include or have access to supporting data that enables it to determine in which geographical region a worker resides or works, including a database of ZIP code or other postal code data. System 10 may also be programmed to define a local area, either by existing geographical or political boundaries or by a radius around a project site. For example, 50 miles may be deemed to be the maximum commuting radius around a particular project, and the workforce availability analysis may include only workers within that defined radius.

Although the illustrations of FIGS. 8-10 display forecast and other data in textual form, the data displayed in the GUI 100 may be displayed in any combination of textual or graphical formats.

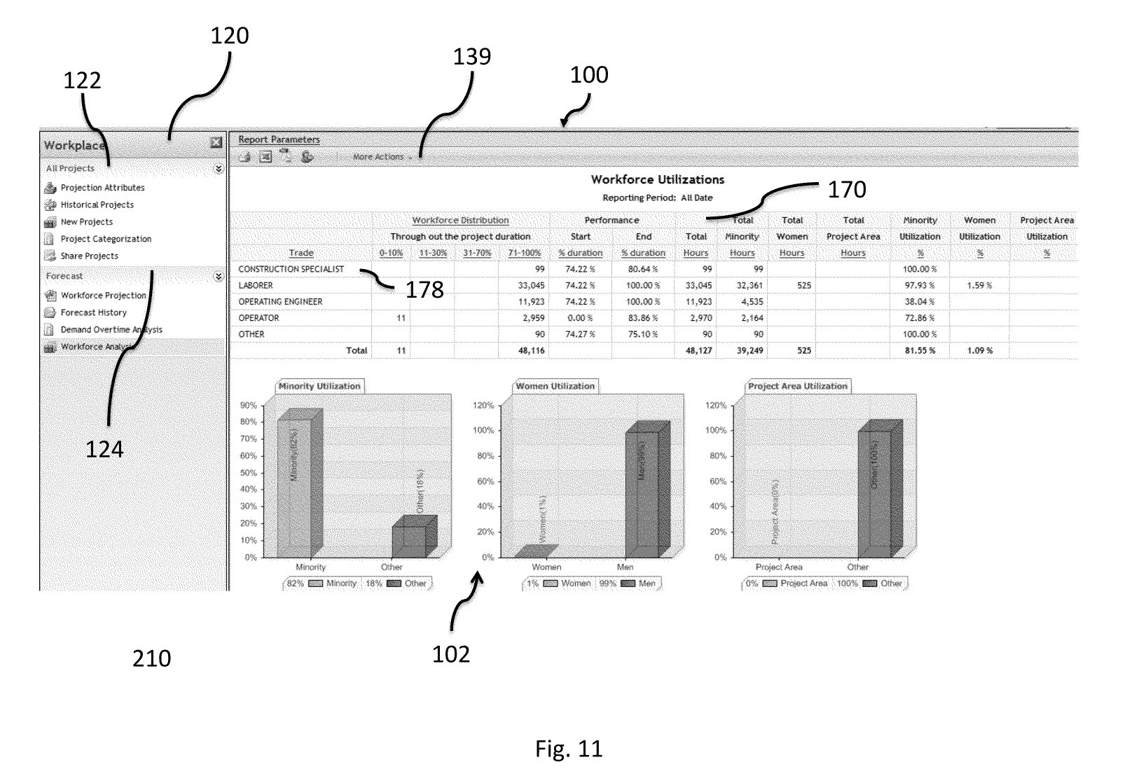

This kind of mixed textual and graphical presentation is shown in the illustration of FIG. 11, which displays demographic data related to the forecasting data. The illustrations of FIGS. 8-10 and the description above focus on general forecasting data usable for project management and budgeting purposes, primarily project costs and workforce utilization. However, other advantageous information can be provided, depending on the historical and other data sources that are available.

For example, certain types of projects require that a body of work utilize a minimum percentage of minority or women in the resource team. Some sources of historical data, like certified payroll reports, include data on the demographic characteristics of the workers. Given information on the geographical location of the project, demographic data from past certified payroll reports or other sources, and workforce utilization forecasts, system 10 and method 50 can also be used to forecast how many workers will be of any particular, tracked demographic characteristic during any particular phase of the project. For example, as shown in FIG. 11, for the illustrated project, 38.04% of operating engineers will be minorities. These additional demographic forecasting functions can help a contractor to comply with federal, state, or other regulations regarding diversity. As those of skill in the art will understand, there are any number of sources of demographic data that are publicly available, and if demographic data is not available in a consolidated form, as is the case with certified payroll reports, public or private databases on individuals may be cross-referenced with data that is available to provide demographic information on a workforce.

Although FIG. 11 focuses on the use of bar graphs to show the demographic composition of the workforce over time, other forms of graphical representation may be helpful using system 10 and method 50, and may be incorporated. For example, the locations of workers in an area or relative to the geographic location of a project may be overlaid on a map using, for example, the Google Maps Application Programming Interface (API; Google, Inc., Mountain View, Calif., USA).

Ultimately, FIGS. 8-11 illustrate a form of workforce supply and demand analysis. In addition to their use in analyzing workforce availability for a particular project, the analyses shown in FIGS. 8-11 allow policymakers and executives to use system 10 and method 50 as a policy and decision support tool. For example, if a particular project requires more of a particular type of tradespeople than are available in a geographical area, policymakers or executives might consider investing in job training programs to bolster the number of tradespeople in those areas. System 10 and method 50 facilitate this type of use by projecting when particular tradespeople will be needed, giving decisionmakers the ability to understand when training programs or other workforce augmentation efforts must be begun and when they must be completed.

Additionally, if a project could be built or completed in any number of places, system 10 and method 50 can help a user to determine where to perform or build the project. Specifically, the analyses described above can be performed for multiple geographical areas and a project location can be chosen that minimizes costs and maximizes the availability of the necessary labor. In that case, the user might save the attributes of the project as a template and change the location multiple times to investigate different locations.

It should be understood that GUI 100 is exemplary, and other forms of interface may be used to gather and present data using system 10 and method 50. Thus, the means of input and output may vary considerably between embodiments and may include any desirable interface features.

While the invention has been described with respect to certain embodiments, the description is intended to be illustrative, rather than limiting. Modifications and changes may be made within the scope of the invention, which is defined by the appended claims.

What is claimed is:

1. A method for forecasting one or more attributes of a project, comprising:
receiving, at a computing system, a selection of at least one relevant project attribute from a user;
providing a listing including a number of historical projects to the user;
receiving, at the computing system, the user's designation of one or more relevant historical projects from the number of historical projects, at least one of the one or more relevant historical projects having data on the at least one relevant project attribute;
scaling the at least one relevant project attribute according to comparable attributes of the one or more relevant historical projects to generate a forecast using the computing system, the forecast including at least a cost projection and a workforce utilization projection; and
providing the forecast to the user.

2. The method of claim 1, wherein the data on the at least one relevant project attribute includes data at the level of an individual worker.

3. The method of claim 2, wherein the data on the at least one relevant project attribute comprises one or more certified payroll reports.

4. The method of claim 2, wherein the data at the level of the individual worker includes geographic data and the forecast further comprises worker availability information for a particular geographic area relevant to the project.

5. The method of claim 2, wherein the data at the level of the individual worker includes demographic data and the forecast further comprises worker demographic data.

6. The method of claim 5, wherein the forecast combines worker demographic data and the workforce utilization projection to establish one or more demographic characteristics of a projected workforce at a particular project phase.
